(19) United States
(12) Patent Application Publication
(10) Pub. No.: US 2017/0164365 A1
(43) Pub. Date: Jun. 8, 2017

(54) CITIZEN BAND RADIO EMULATING DEVICE AND METHOD THEREOF

(71) Applicant: John M. DeCoster, Malibu, CA (US)

(72) Inventor: John M. DeCoster, Malibu, CA (US)

(21) Appl. No.: 14/957,239

(22) Filed: Dec. 2, 2015

(51) Int. Cl. H04W 72/04; H04W 4/00

(52) U.S. Cl. CPC H04W 72/0453; H04W 4/008

(57) ABSTRACT

A Citizen Band (CB) radio emulating device is disclosed. The device comprises a CB transceiver unit that receives and transmits radio frequency within CB frequency range; an antenna port for connecting an antenna to the CB transceiver unit for enhancing the CB transceiver unit's transmission performance; a power port for receiving power supply for the CB transceiver unit; a transmitting unit that establishes a communication with an electronic device, allowing the CB transceiver unit to receive and execute control instructions from the electronic device; and a casing that encloses the CB transceiver unit, the antenna port, the power port and the transmission unit; wherein at least the CB transceiver unit's channel and frequency are adjusted via instructions received from the electronic device.

### FIELD OF THE DISCLOSURE

The present disclosure generally relates to systems and methods for emulating Citizen Band radio. More specifically, the present disclosure discloses a telecommunication device and method that allows a user to emulate Citizen Band radio on electronic devices such as an automobile audio system, mobile phone and tablet computer.

### BACKGROUND OF THE INVENTION

Citizens Band (CB) radio is, in many countries, a system of short-distance radio communications between individuals on a selection of multiple channels (e.g., 40) within a specified band (e.g., the 27 MHz (11 m)). Citizens band is distinct from the FRS, GMRS, MURS, and Amateur Radio Service systems. In most countries, CB operation does not require a license, and it may be used for business or personal communications.

The radio technology for CB radio is basically push-to-talk, with Federal Communications Commission (FCC) regulations on power output in the United States. Like many other two-way radio services, CB channels are shared by many users. Only one station may transmit at a time; other stations must listen and wait for the shared channel to be available. It is customary for stations waiting to use a shared channel to broadcast the single word “Break” during a lull in the conversation. This informs people using the channel that others are waiting.

As such, the use of CB radio has become common since it became popularized in the 1970s. While it is most commonly associated with truckers, its attraction is more widespread because it has become known as a medium for “communities of interest.” Many people have compared CB to a party line on the air.

Conventional base stations for CB radios are usually large in size because they require many hardware components such as microphone, speaker, knobs, dials, switches and/or display monitor etc. As such, conventional CB radios can take up a lot of spaces, which is very inconvenient for some users especially users in a confined space such as an automobile. The manufacturing cost for the conventional CB radio also cannot be greatly reduced as long as these hardware components are required.

Accordingly, there exists a need for improved devices and methods for reducing the size of CB radio's base stations. There also exists a need for improved devices and methods that allow users to emulate CB radio on existing electronic devices such as mobile phone, thereby reducing the manufacturing cost of CB radio.

### SUMMARY OF THE INVENTION

A telecommunications device and method is disclosed for emulating Citizen Band (CB) radio on electronic devices such as automobile audio or entertainment system, mobile phone and/or tablet computer, thereby reducing the number of hardware components required for CB radios and their manufacturing cost.

In accordance with one aspect of at least one embodiment of the present disclosure, a Citizen Band (CB) radio emulating device is disclosed. The device comprises: 1) a CB transceiver unit that receives and transmits radio frequency within CB frequency range; 2) an antenna port for connecting an antenna to the CB transceiver unit for enhancing the CB transceiver unit's transmission performance; 3) a power port for receiving power supply for the CB transceiver unit; 4) a transmitting unit that establishes a communication between the CB transceiver unit and an electronic device, allowing the CB transceiver to at least receive and execute control instructions sent from the electronic device; and 5) a casing that encloses the CB transceiver unit, the antenna port, the power port and the transmission unit; wherein at least the CB transceiver unit's channel or frequency is adjusted via control instructions received from the electronic device.

These and other features, aspects and advantages of the present invention will become better understood with reference to the following drawings, description and claims.

### BRIEF DESCRIPTION OF THE DRAWINGS

FIG. 1 is a schematic diagram according to an exemplary embodiment of the present invention.

FIG. 2 is a schematic diagram according to an exemplary embodiment of the present invention.

FIG. 3 is a schematic diagram according to an exemplary embodiment of the present invention.

### DETAILED DESCRIPTION OF THE PREFERRED EMBODIMENT(S) AND INVENTION

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

For purposes of the present disclosure, the term “Citizen Band (CB) radio” generally refers to any devices that transmits and receives radio signals only within a designated band of frequencies. For example and not by way of limitation, the conventional CB radio has a frequency band of 40 channels for public radio transmission in the 27 MHz range. CB radio uses the same frequencies for sending and receiving on each channel (half duplex transmission).

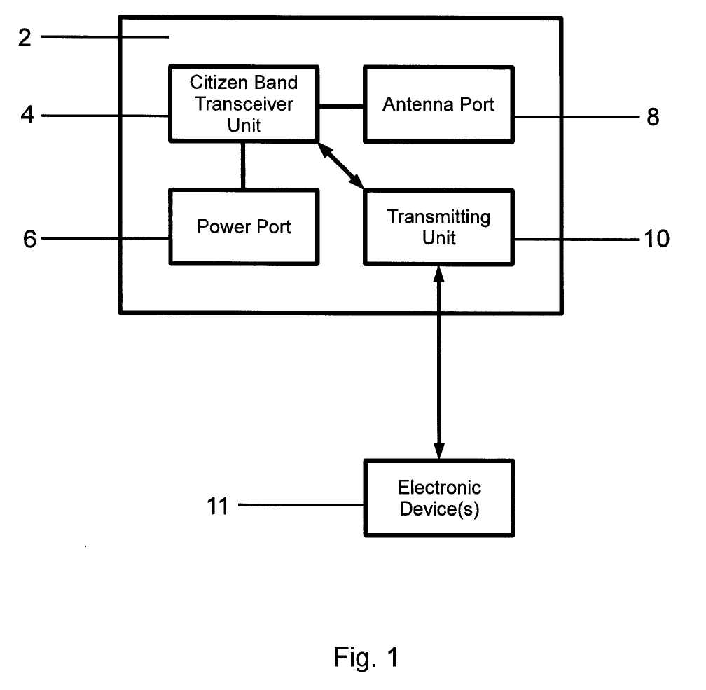

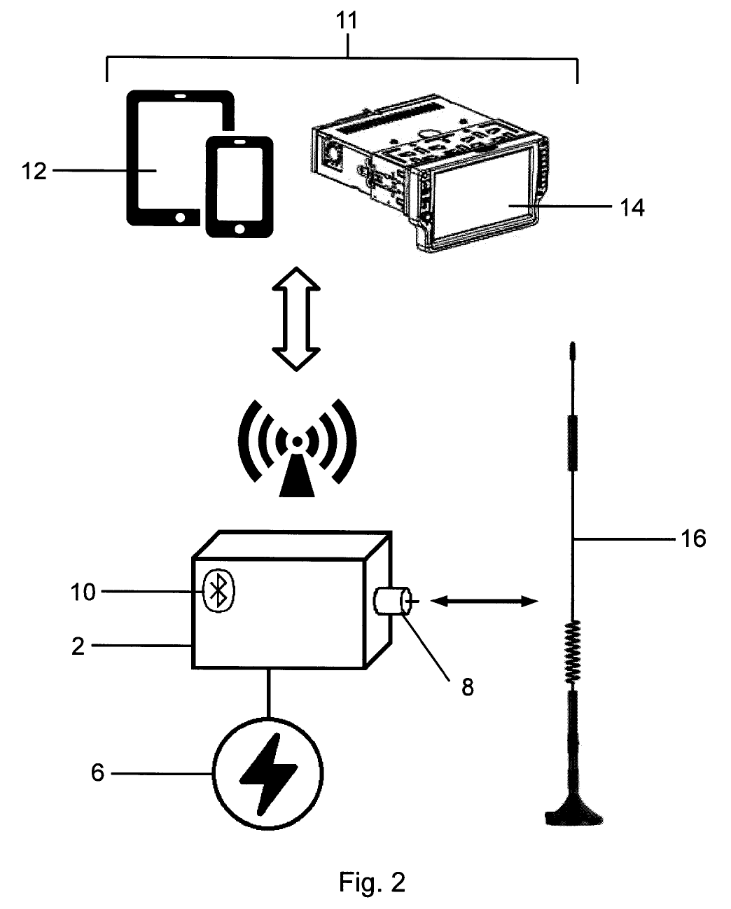

Broadly, embodiments of the present disclosure generally provide a device for emulating Citizen Band (CB) radio on electronic devices. As shown by FIGS. 1 and 2, in one embodiment of the present disclosure, the disclosed CB radio emulating device 2 comprises: a CB transceiver unit 4 that receives and transmits radio frequency within general CB frequency range (e.g., between 26.965 MHz and 27.405 MHz); an antenna port 8 for connecting additional and external antenna 16 to the CB transceiver unit 4 for enhancing the CB transceiver unit's 4 transmission performance and/or quality; a power port 6 for receiving power supply for the CB transceiver unit 4; a transmitting unit 10 that establishes a bidirectional communication between CB transceiver unit 4 and electronic device(s) 11, allowing the CB transceiver unit 4 to receive and execute control instructions from the electronic device 11; and a casing that encloses the CB transceiver unit 4, the antenna port 8, the power port 6 and the transmission unit 10. The CB radio emulating device 2 is configured in a way that at least CB transceiver unit's 4 channel and frequency (transmitting and receiving) are adjustable via instructions received from the electronic device 11.

As shown by FIG. 2, the electronic device 11 can be mobile device(s) 12 such as mobile phone or tablet computer, or it can be an automobile DVD player, GPS system, audio system or in-dash multimedia entertainment system 14 with a monitor. Preferably, the monitor is a touch-screen monitor for better control. When mobile phone and/or tablet computer is used, their speaker and microphone will be used as the speaker and microphone for the CB radio, such that the CB radio emulating device 2 does not need to provide additional speaker and microphone.

In one embodiment of the present disclosure, the power port 6 is connected, directly or indirectly, to an automobile's battery or power source, a power outlet or to a battery or batteries (internal or external) depending on where the CB radio emulating device 2 is used by the user. For example and not by way of limitation, if the CB radio emulating device 2 is used on automobiles such as trucks, it would be logical for the CB radio emulating device 2 to use automobile's power source (e.g., 12V+ power from automobile battery). An internal rechargeable battery can also exist at the same time so that CB radio transmissions will not be affected if the power from automobile is interrupted. If the CB radio emulating device 2 is used on places without power source (such as carried by a person), then a battery, preferably rechargeable battery should be used as the power source instead for the CB radio emulating device 2. In this case, additional battery charging port should be included on the CB radio emulating device 2 so that the rechargeable battery can be recharged directly.

The antenna port 8 allows external antenna 16 to be installed on the CB radio emulating device 2 to enhance the transmission and reception quality of CB radio. Alternatively, the Antenna port 8 can be replaced or coexisted with a built-in antenna for design convenience.

The transmitting unit 10 provides wireless and/or wired transmission between the CB radio emulating device 2 and the electronic device 11. If the transmission is wireless, known technologies for short-range and long-range wireless communication such as Bluetooth, infrared, radio frequency, IEEE 802.11 and Communications Access for Land Mobiles (CALM) can be used. For instance, if the electronic device 11 is a mobile device 12 like mobile phone or tablet computer, the use of Bluetooth and IEEE 802.11 are preferred as they provide more stable and convenient connections for existing mobile devices. If the electronic device 11 is an audio system or in-dash multimedia entertainment system 14, then wired and direct connection is preferred if they are located close to together. The main purpose of transmitting unit 10 is to transmit everything CB radio emulating device 2 (or CB transceiver unit 4) receives (e.g., other user's voice) to the electronic device 11, and receives instruction (e.g., selection of frequency or channel) and user's voice from the electronic device 11.

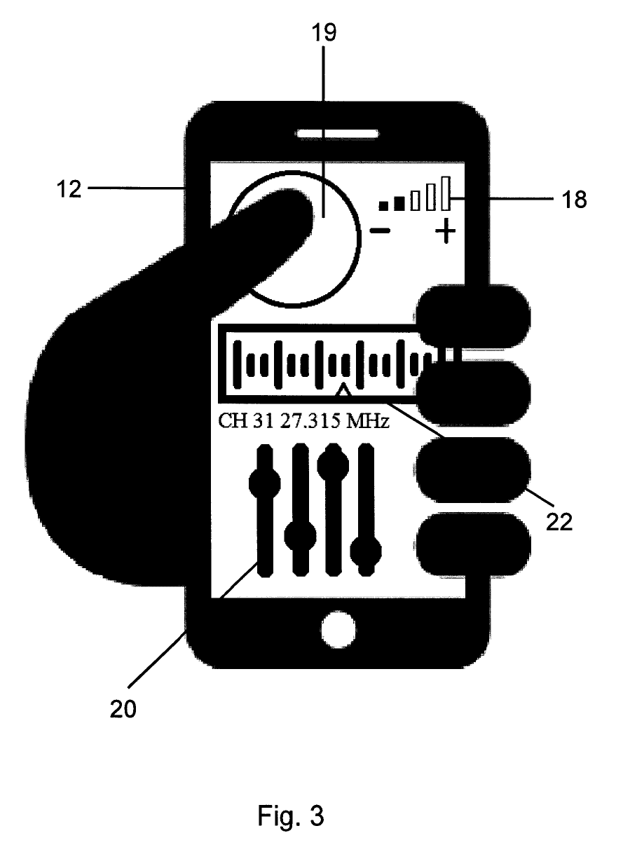

In yet another embodiment of the present disclosure, as shown by FIG. 3, the electronic device 11 such as mobile phone or tablet computer provides a user interface generated by a mobile application or software (e.g., on Android and ios). The user interface may include conventional CB radio functions such as channel and/or frequency selector 20, volume selector/adjuster 18 (which can be controlled virtually on a touch screen or with the phone's physical volume button) and a switch button 19, preferably a virtual switch button, which the user must press once before the user speaks or press continuously while the user is speaking like conventional CB radio. Accordingly, once a communication is established between the CB radio emulating device 2 and the electronic device 11, the user can emulate the CB radio on the electronic device 11 using the available CB radio functions.

The user interface may further include virtual controls 20 that allow the user to adjust various parameters of CB radio like conventional CB radio. For example and not by way of limitation, the parameters that can be adjusted may include microphone gain or dynamic, radio frequency (RF) gain, squelch, AM Upper Side Band (USB) Lower Side Band (LSB), clarifier, specified channel switch and Standing Wave Ratio (SWR). Effect of each parameter is illustrated below:

1) Microphone Gain or Dynamic—Adjusts modulation of frequency of CB radio up or down until the user's voice is clear to others.

2) RF Gain—Adjusts user's reception. Usually set all the way up. Turning it down will cut out distant and weak stations and the user will only hear those close to the user. This should not affect user's transmission.

3) Squelch—Adjusts amount of static that the user hears. When no one is talking, it is usually turned all the way down and then up slowly until the user can't hear anything. When someone starts talking the user will still hear them unless they are far away or a weak station. While talking to someone who is getting farther away, turn squelch all the way down to be able to hear them for as long as possible.

4) AM USB LSB—Should be kept on AM. USB (upper side band) and LSB (lower side band) are seldom used on a CB. User can talk greater distances on sidebands but only if the person the user is talking to is using the same.
Clarifier—used to tune in sideband stations.

5) Specified Channel Switch (e.g., CH 9 or CH 19 Switch)—Instantly tunes user to that station.

6) SWR/RF/SET—Switches user's meter to the different options. Normally kept on RF or SIG (depending on the radio) to see user's performance and the signal strength of incoming signals. SWR can be used to adjust the antenna 16 through a process called antenna tuning.

In yet another embodiment of the present disclosure, the CB transceiver unit 4 is made with a standard CB receiver circuitry that receives and sends CB transmissions. The CB receiver circuitry should include a microcontroller, a timer and plurality of transistors.

In yet another embodiment of the present disclosure, a method of emulating CB radio on an electronic device is disclosed. The method comprises 1) providing a CB radio emulating device that includes: a CB transceiver unit that receives and transmits radio frequency within CB frequency range; an antenna port for connecting an antenna to the CB transceiver unit for enhancing the CB transceiver unit's transmission performance; a power port that receives electricity from an automobile's power supply and delivers the electricity to the CB transceiver unit; a transmission unit that establishes a wireless communication between the CB transceiver unit and a mobile device, allowing the CB transceiver unit to receive and execute control instructions from the mobile device; a casing that encloses the CB transceiver unit, the antenna port, the power port and the transmission unit; 2) providing a non-transitory computer-readable medium storing software that is installed on a mobile device which provides a user interface with CB radio functions; wherein the CB radio functions are selected from a group consisting of selecting CB radio channels and frequencies, adjusting speaker volume of the mobile device and providing a virtual switch button which the user must press once before the user speaks or press continuously while the user is speaking; 3) establishing a communication between the CB radio emulating device and the mobile device; and 4) emulating the CB radio on the mobile device by using the CB radio functions.

In yet another embodiment of the present disclosure, the present disclosure is applied to a conventional CB radio. For example, the transmitting unit 10 is installed on an existing CB radio and is configured in a way to allow the CB radio to communicate with and to be controlled by an electronic device such as a mobile phone and performs functions described above. This provides a CB radio that can work both as stand-alone CB radio and CB radio emulating device upon user's desire. The conventional CB radio here will comprise all the basic hardware components (e.g., microphone, speaker, channel/frequency selector) required by a typical CB radio.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A Citizen Band (CB) radio emulating device, the device comprising:
a CB transceiver unit that receives and transmits radio frequency within CB frequency range;
an antenna port for connecting an antenna to the CB transceiver unit for enhancing the CB transceiver unit's transmission performance;
a power port for receiving power supply for the CB transceiver unit;
a transmitting unit that establishes a communication between the CB transceiver unit and an electronic device, allowing the CB transceiver unit to receive and execute control instructions from the electronic device;
a casing that encloses the CB transceiver unit, the antenna port, the power port and the transmission unit; and
wherein at least the CB transceiver unit's channel and frequency are adjusted via instructions received from the electronic device.

2. The device of claim 1, wherein the power port is connected, directly or indirectly, to an automobile's battery or power source, or to a rechargeable battery inside the casing.

3. The device of claim 1, wherein the transmitting unit establishes a bidirectional wireless communication with the electronic device via Bluetooth.

4. The device of claim 1, wherein the electronic device is a mobile phone or tablet computer.

5. The device of claim 4, wherein the mobile phone or tablet computer displays a user interface generated by a mobile application or software installed on the mobile phone or tablet computer allowing the user to emulate CB radio functions on the mobile phone or tablet computer.

6. The device of claim 5, wherein the user interface has virtual controls that allow the user to adjust multiple parameters of CB radio selected from a group consisting of microphone gain or dynamic, radio frequency (RF) gain, squelch, AM Upper Side Band (USB) Lower Side Band (LSB), clarifier, specified channel switch and Standing Wave Ratio (SWR).

7. The device of claim 5, wherein the mobile phone or tablet computer's speaker and microphone are used by the mobile application or software to allow the user to speak and listen to other users on a CB channel.

8. The device of claim 5, wherein the user interface has a virtual switch button which the user must press once before the user speaks or press continuously while the user is speaking.

9. The device of claim 1, wherein the electronic device is an automobile DVD player, GPS system, audio system or in-dash multimedia entertainment system with a monitor.

10. The device of claim 9, wherein the monitor is a touch-screen monitor.

11. A Citizen Band (CB) radio emulating device, the device comprising:
a CB transceiver unit that receives and transmits radio frequency within CB frequency range;
an antenna port for connecting an antenna to the CB transceiver unit for enhancing the CB transceiver unit's transmission performance;
a power port that receives electricity from an automobile's power supply and delivers the electricity to the CB transceiver unit;
a Bluetooth unit that establishes a wireless bidirectional communication between the CB transceiver unit and a mobile device, allowing the CB transceiver unit to receive and execute control instructions from the mobile device;
a casing that encloses the CB transceiver unit, the antenna port, the power port and the transmission unit;
wherein the mobile device displays a user interface generated by a mobile application or software to allow a user to emulate CB radio functions on the mobile device; and
wherein the CB radio functions include at least selecting CB radio channels and frequencies, adjusting speaker volume of the mobile device and a virtual switch button which the user must press once before the user speaks or press continuously while the user is speaking.

12. The device of claim 11, wherein the mobile device is a mobile phone or tablet computer.

13. The device of claim 11, wherein the user interface has virtual controls that allow the user to adjust multiple parameters of CB radio selected from a group consisting of microphone gain or dynamic, radio frequency (RF) gain, squelch, AM Upper Side Band (USB) Lower Side Band (LSB), clarifier, specified channel switch and Standing Wave Ratio (SWR).

14. The device of claim 11, wherein the CB transceiver unit comprises a standard CB receiver circuitry for receive and send CB transmissions.

15. The device of claim 14, wherein the standard CB receiver circuitry has at least a microcontroller, a timer and a plurality of transistors.

16. A method of emulating CB radio on an electronic device, the method comprises:
providing a CB radio emulating device that includes:
a CB transceiver unit that receives and transmits radio frequency within CB frequency range;
an antenna port for connecting an antenna to the CB transceiver unit for enhancing the CB transceiver unit's transmission performance;
a power port that receives electricity from an automobile's power supply and delivers the electricity to the CB transceiver unit;
a transmission unit that establishes a wireless communication between the CB transceiver unit and a mobile device, allowing the CB transceiver unit to receive and execute control instructions from the mobile device;
a casing that encloses the CB transceiver unit, the antenna port, the power port and the transmission unit;
providing a non-transitory computer-readable medium storing software that is installed on a mobile device which provides a user interface with CB radio functions;
wherein the CB radio functions are selected from a group consisting of selecting CB radio channels and frequencies, adjusting speaker volume of the mobile device and providing a virtual switch button which the user must press once before the user speaks or press continuously while the user is speaking;
establishing a communication between the CB radio emulating device and the mobile device; and
emulating the CB radio on the mobile device by using the CB radio functions.

17. The device of claim 16, wherein the transmitting unit establishes the communication with the mobile device via Bluetooth.

18. The device of claim 16, wherein the mobile device is a mobile phone or tablet computer.

19. The device of claim 16, wherein the user interface further includes virtual controls that allow the user to adjust multiple parameters of CB radio, wherein the multiple parameters are selected from a group consisting of microphone gain or dynamic, radio frequency (RF) gain, squelch, AM Upper Side Band (USB) Lower Side Band (LSB), clarifier, specified channel switch and Standing Wave Ratio (SWR).

20. The device of claim 16, wherein the power port only receives 12V+ power.
